(19) United States
(12) Patent Application Publication
(10) Pub. No.: US 2013/0261996 A1
(43) Pub. Date: Oct. 3, 2013

(54) Self Calibrating Capacitive Fuel Sensor

(71) Applicant: STARTRAK INFORMATION TECHNOLOGIES, LLC, Morris Plains, NJ (US)

(72) Inventor: Herbert Perten, Suffern, NY (US)

(73) Assignee: STARTRAK INFORMATION TECHNOLOGIES, LLC, Morris Plains, NJ (US)

(21) Appl. No.: 13/841,517

(22) Filed: Mar. 15, 2013

Related U.S. Application Data
(60) Provisional application No. 61/616,148, filed on Mar. 27, 2012.

(51) Int. Cl. G01F 23/26

(52) U.S. Cl. CPC G01F 23/261
USPC 702/55

(57) ABSTRACT

A method and apparatus are provided for determining a level of fuel in a tank, comprising determining a dielectric constant of fuel in a tank; measuring a capacitance of an unknown depth of the fuel in the tank; and calculating the depth using the dielectric constant and the capacitance. Embodiments of the apparatus utilize a capacitor plate submerged in the fuel to determine the dielectric constant of the fuel, and then use a plate of a separate capacitor to determine the fuel level, once the dielectric constant is known.

### CROSS REFERENCE TO RELATED APPLICATIONS

The present application claims the benefit of U.S. Provisional Application No. 61/616,148, filed Mar. 27, 2012, entitled, “Self Calibrating Capacitive Fuel Sensor”, herein incorporated by reference.

### BACKGROUND

Internal combustion engines fueled by liquid diesel or gasoline are used in a variety of mobile and stationary applications. In many of these, it is desirable to monitor the fuel level at any given time to ensure that an ample supply is always present. Current state of the art sensors include those operating on sensing the positions of floats, sensors using ultrasonic techniques to gage the fuel level, and sensors using capacitive techniques to infer the fuel level. It is to this last type that the herein disclosed systems and methods are related to.

Capacitive fuel sensors work on the principle that the dielectric constant of fuel is markedly different from that of air (approximately twice as big). Such sensors are constructed such that two conductors (the plates of a capacitor) are inserted in the fuel from the top of the tank. For the part of the conductors that is submerged in the fuel, the dielectric will be the fuel; for the part remaining, the dielectric will be air. The total capacitance will be the algebraic sum of the capacitances for each section:

Cₜₒₜₐₗ=C_{fuel}+Cₐᵢᵣ (1)

For a parallel plate capacitor, the capacitance is proportional to the dielectric constant of the insulating medium between the plates and the height of that medium:

$${c}_{parallel} = \frac{{ε}_{0} {ε}_{r} wh}{d} \qquad ( 2 )$$

where:

ε₀ is the dielectric constant of a vacuum (8.854×10⁻¹² F/m)

εᵣ is the relative dielectric constant of the insulating substance (unitless)

W is the width of the parallel plates

h is the height of the parallel plates

d is the distance between the parallel plates

If the geometry (w, d) is constant, Equation 2 reduces to:

Cₚₐᵣₐₗₗₑₗ∝εᵣh (3)

For a cylindrical capacitor, the capacitance is also proportional to the dielectric constant of the insulating medium and the height of that medium:

$${c}_{cyl} = \frac{2 {πε}_{0} {ε}_{r} h}{ln \frac{b}{a}} \qquad ( 4 )$$

where:

ε₀ is the dielectric constant of a vacuum (8.854×10⁻¹² F/m)

εᵣ is the relative dielectric constant of the insulating substance (unitless)

h is the height of the coaxial capacitor

b is the diameter of the outer cylinder

α is the diameter of the inner cylinder

If the geometry (b,a) is constant, Equation 4 reduces to:

C_{cyl} ∝ εᵣh (5)

Folding Equations (2) and (3) into (1) we see that:

Cₜₒₜₐₗ ∝ εᵣ_{_{fuel}}h_{fuel}+εᵣ_{ₙᵢᵣ}hₐᵢᵣ (6)

Since the total height h of the sensor is known, (6) may be reduced to:

Cₜₒₜₐₗ ∝ εᵣ_{_{fuel}}h_{fuel}+εᵣ_{ₐᵢᵣ}(h−h_{fuel})

or

Cₜₒₜₐₗ ∝ εᵣ_{ₐᵢᵣ}h+h_{fuel}(εᵣ_{_{fuel}}−εᵣ_{ₐᵢᵣ}) (7)

Since h and εᵣ_{ₐᵢᵣ} may be assumed to be constant, (7) reduces to:

Cₜₒₜₐₗ ∝ constant+h_{fuel}(εᵣ_{_{fuel}}−εᵣ_{ₐᵢᵣ}) (8)

Thus, if εᵣ_{_{fuel}} is constant, the measured capacitance is proportional to the height of the fuel and may be used to infer the level of the fuel. This is the principle upon which capacitive fuel sensors operate.

However, the dielectric constant of the fuel is not always the same. Different additives, for example, can cause this value to change significantly. Other patents explain how to measure the dielectric constant of a sample of fuel and use this to infer its composition. For example, U.S. Pat. No. 7,800,379 by Hernandez et al. (“the '379 Patent”) describes a system by which the concentration of ethanol in a fuel sample is inferred by measuring the dielectric constant of a sample of the fuel. This patent shows a variability of nearly 4:1 in the dielectric constant of fuel to which ethanol has been added.

FIG. 1 shows a prior art capacitive fuel sensor 1. An implementation having outer and inner concentric electrically conductive cylinders is illustrated, but other geometries may be used as well. The sensor 1 is affixed to a fuel tank 2 having fuel of level 5. The outer 3 and inner 4 conductive cylinders are connected to electronics 8 with wires 10 and 9 respectively. In a common implementation of such a sensor, the outer cylinder has an outside diameter of ½″ and the inner cylinder has an outside diameter of ⅛″. Lengths commonly in use today may vary from as little as 15″ or less to as much as 36″ or more. The electronics are enclosed in a protective case 7 which may also be used for mounting of the sensor to the tank.

In an implementation, the case is about 3″ in diameter by about ½″ inch thick. The cylinders may be made from rigid tubing, from stiff springs such as compression springs, or other materials, without adversely affecting the operation of the disclosed sensors. The fuel level is reported to the outside world via an external connector 6. The reporting signal may be in the form of an analog voltage proportional to the fuel height, an analog current proportional to the fuel height, a digital signal conveying the height information, or the like, for example. It also may be a wireless signal conveyed by a wireless transmitter.

In operation, electronics 8 computes the capacitance between the inner and outer cylinders, and uses this in combination with an assumed fuel dielectric value to infer the fuel level as described above. One prior art implementation having the tube dimensions cited above shows a sensitivity of about 1.27 pf/in for diesel fuel.

FIG. 1 represents the state of the prior art in capacitive based fuel sensors. Given a default value for the dielectric constant of the fuel, it will give a reasonable indication of the level of the fuel. However, it has been experimentally confirmed that the dielectric constant of diesel fuel may vary by as much as 10%. Further, the '379 Patent indicates a nearly 400% change in dielectric constant for gasoline with ethanol added. This variability results in a proportional error in the fuel level sensing achieved by prior art capacitive fuel sensors. Though such sensors may be adequate for an “Empty-Half-Full” indication, they are insufficient for applications requiring measurement of fuel level to a much higher degree of accuracy, for example, within 1% of the true value.

### SUMMARY

The prior art capacitive sensors are subject to errors due to the variability of the dielectric constant of the fuel. The herein described systems and methods can compensate for these errors.

Accordingly, a self-calibrating liquid fuel level sensor is provided, comprising: a calibrator that determines a dielectric constant of a liquid fuel; a fuel depth capacitance sensor that determines a capacitance of an unknown depth of the fuel; and a processor that calculates a determined depth based on the unknown depth using the dielectric constant and the capacitance. The sensor may further comprise: a first conductive member that acts as a charge plate of a first capacitor; a second conductive member that is electrically isolated from the first conductor member that acts as a charge plate of a second capacitor ; and a third conductive member that acts as an opposite charge plate of the first capacitor and the second capacitor; wherein the calibrator comprises the first conductive member, the third conductive member, and elements for determining capacitance including a processor comprising algorithms.

Further, a method is provided for determining a level of fuel in a tank, comprising: determining a dielectric constant of fuel in a tank; measuring a capacitance of an unknown depth of the fuel in the tank; and calculating the depth using the dielectric constant and the capacitance.

The determining of the dielectric constant may comprise: providing a first conducting member that acts as a charge plate of a first capacitor; providing a second conductive member that is electrically isolated from the first conductor member that acts as a charge plate of a second capacitor; providing a third conductive member that acts as an opposite charge plate of the first capacitor and the second capacitor; completely submerging the first conducting member in the fuel; measuring a capacitance of the first capacitor; and calculating the dielectric constant based on the measured capacitance of the first capacitor.

### DESCRIPTION OF THE DRAWINGS

FIG. 1 is a pictorial diagram illustrating a known fuel level system;

FIG. 2 is a pictorial diagram illustrating an embodiment of the inventive fuel level system;

FIG. 3A is a pictorial/schematic diagram illustrating various system capacitances;

FIG. 3B is a simple schematic diagram illustrating the various system capacitances shown in FIG. 3A;

FIG. 4 is a circuit schematic of the sensor system;

FIG. 5 is a flowchart illustrating an embodiment of the inventive method;

FIG. 6 is a circuit schematic of an embodiment of a detector; and

FIG. 7 is a flowchart illustrating an embodiment of the inventive method.

### DETAILED DESCRIPTION

As discussed above, the prior art utilizes the variability in the dielectric constant of fuel to infer the composition of the fuel. In contrast, the herein disclosed systems and methods use the variability of the dielectric constant of fuel in a fuel tank to accurately determine the fuel level in the tank.

As the analysis presented previously shows, a 4:1 change in the dielectric constant of a fuel sample would introduce a significant error in the reported height of the fuel. The present disclosure teaches systems and methods of compensating for the effect of dielectric constant change on the reported height of the fuel. It presents a novel capacitive fuel sensor design and an illustrative implementation with exemplary electronics and firmware. The novel design may be used to determine a more accurate reporting of the level of fuel in a tank than can be achieved using prior art capacitive fuel sensors.

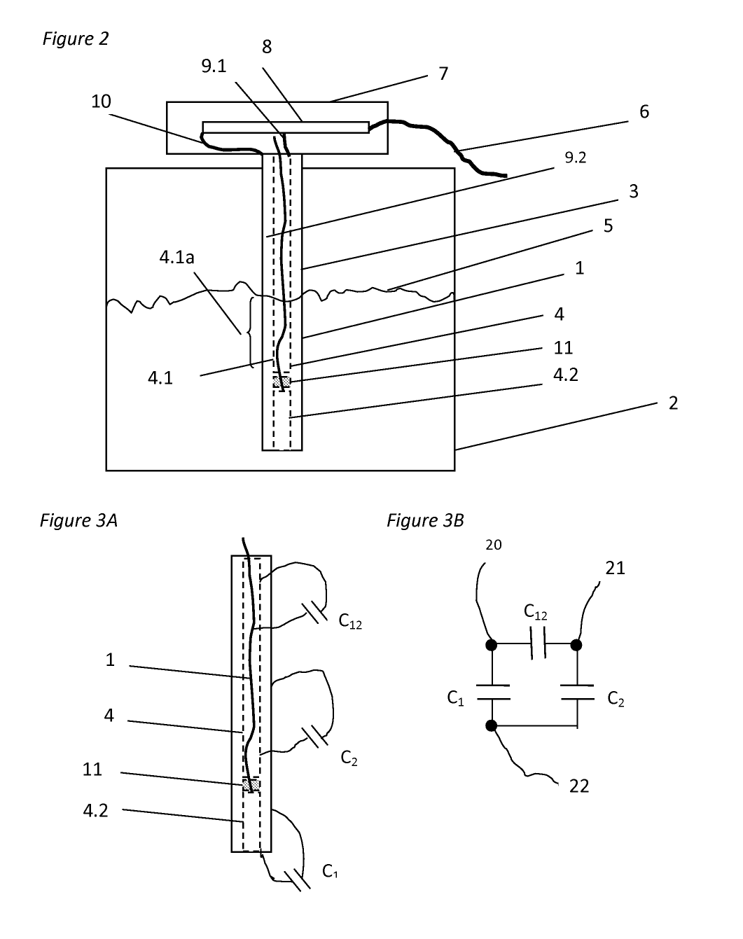

In an exemplary embodiment shown in FIG. 2, a capacitive fuel sensor 1 has a first conducting plate 3 and a second conducting plate 4, for example, an outer electrically conductive cylinder 3 and a concentric inner conductive cylinder 4, although other geometries may also be used. One plate, such as the inner cylinder 4 of two concentric conductive cylinders, comprises two sections of known length, a first section 4.1, and a second section 4.2. The plates 3, 4 are inserted into a fuel tank 2, such as through a hole in the top of the tank when the sensor 1 is mounted on the tank 2. When the tank 2 contains fuel, if the amount of fuel 5 in the tank is sufficient to immerse the entire bottom section 4.2 of the two-section plate 4 and at least a portion 4.1a of the top section, the bottom section 4.2 may be used to calculate the dielectric constant of the fuel in the tank. This value, which is specific to the fuel in the tank, is then used to calculate the height of the of the fuel column 5 between the sensor's outer 3 and inner 4 cylinders.

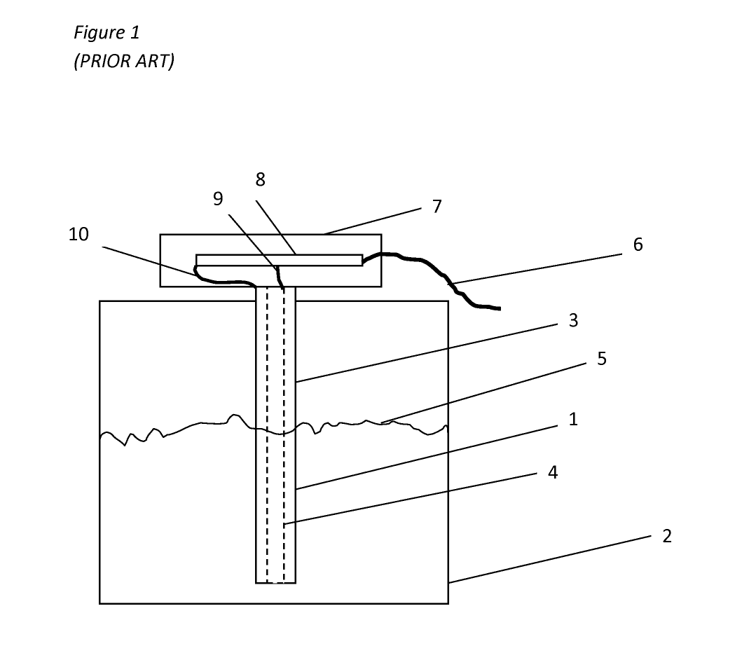

FIG. 2 is identical to FIG. 1 for items 1-10, but differs in that the inner cylinder 4 is shortened; an electrical insulator 11 is affixed to the bottom of the top inner conductive cylinder portion 4.1; and the second, shorter bottom inner conductive section of the center cylinder 4.2 is attached to the insulator's 11 bottom. The length of the insulator 11 is made as short as practicable, because it introduces a dead band to the measurements. A representative size might be ⅛″, for example. The conductive wire 9 for the inner conductive cylinder has been split in two: a top inner conductive cylinder wire 9.1 and bottom inner conductive cylinder wire 9.2, the latter providing a separate electrical connection between the bottom section and the electronics 8. This wire may be threaded through the inside of the upper section 4.1 of the inner cylinder 4. In an exemplary embodiment, the bottom section is 1″ in length.

For fuel levels 5 that do not completely submerge the entire bottom section 4.2 of the center cylinder 4, the system may use a default or previously calculated value for the dielectric constant of the fuel, and treats the two sections 4.1, 4.2 of the center cylinder 4 as if they were one, i.e., as if the system were built as in FIG. 1.

A calibrator is used to determine the dielectric constant of the liquid fuel in the tank. In an embodiment, the calibrator uses the bottom section 4.2 and calculation algorithms associated with measured values related to the bottom section 4.2. For fuel levels 5 that do completely submerge the bottom section 4.2 of the center cylinder 4, the capacitance of the bottom section 4.2 is first determined. Since its length is known (1″ in this example), the dielectric constant of the fuel may be calculated. That dielectric constant may then be used to compute the length of the fuel column in which the top section 4.1 is immersed. In one embodiment, the two sections 4.1, 4.2 of the inner cylinder 4 are then electrically coupled together, and the newly calculated dielectric constant is then used to compute the fuel level 5.

The capacitances which are measured are shown schematically in FIGS. 3A, 3B, which is an excerpt of FIG. 2 with additional detail added. C₁ is the capacitance from the lower section 4.2 of the center cylinder 4 to the outer cylinder 3. C₂ is the capacitance from the upper section 4.1 of the center cylinder 4 to the outer cylinder 4. Depending on the geometry of the sensor sections and the size of the capacitances being measured, the capacitance from the outer cylinder 3 to the wire 9.2 leading from the bottom portion 4.2 of the inner cylinder 4 through the upper inner cylinder 4.1 may be significant. This is indicated as C₁₂. The three capacitances are illustrated in FIG. 3A as capacitors on a section of the fuel sensor and also (FIG. 3B) schematically. Available connections brought up to the electronics are shown as connection points 20, 21 and 22.

The capacitance values may be determined by any of several methods which will be known to one of ordinary skill in the pertinent art. In one method, a inductor of known inductance is placed in parallel with the capacitor of unknown capacitance, and the resonant frequency of the parallel inductor-capacitor network is measured. From this, the value of the unknown capacitor may be determined. Another method measures the charging (and/or discharging) time constant formed by charging (or discharging) the capacitor through a resistor of known resistance. This resistor-capacitor network may be incorporated in a free running multivibrator, in which case the oscillation period may be used to determine the unknown capacitor. Another implementation may involve timing the charging of the capacitor to a known threshold and using this to determine the capacitor's value. The systems and methods disclosed herein are not affected by the method used. For purposes of illustration, a resistor-capacitor network is presented below, and a generic control block is used for timing and thresholds.

### Hardware Design

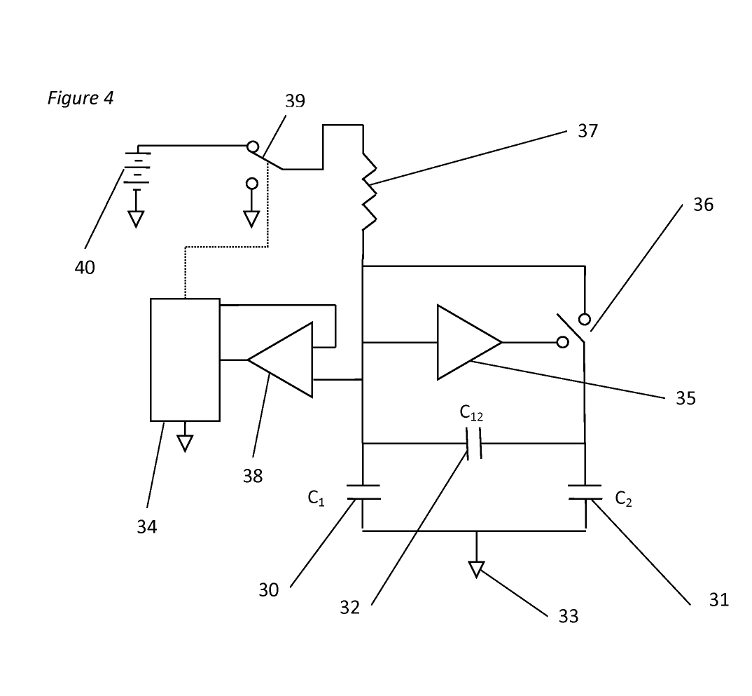

FIG. 4 shows a schematic representation of an exemplary implementation of the electronics which may be used to read the capacitances in the illustrative sensor embodiment. C₁, C₂ and C₁₂ are as described above, and are labeled as items 30, 31 and 32 respectively. The outer cylinder is defined to be at a reference “ground” potential 33, which is also used elsewhere in the system. A unity gain analog buffer amplifier 35 presents the voltage at the top of C₁ at its output. Switch 36 allows the top of C₂ to be either connected to the top of C₁ (placing the two capacitors in parallel) or to the output of the buffer amplifier 35 (whose voltage is identical to that at the top of C₁). Resistor 37 is used to charge the unknown capacitance from a voltage source provided by controller 34. A level comparator 38 changes state when the voltage on C₁ exceeds or falls below a threshold set by controller 34, thereby allowing controller 34 to change its operating mode when this occurs. The controller 34 has an output which can control the position of switch 39, connecting either a voltage source (represented here by battery 40) or ground to the top of resistor 37. Thus, the capacitor network 30, 31, 32 can be charged and discharged. Since the values of the resistor 37and the comparator 38 thresholds are known, the controller 34 can measure charge and discharge times and calculate the unknown capacitor value using the standard exponential charge and discharge formulae for resistor-capacitor networks.

Operation of this System

If it is desired to read the whole length of the sensor 1 (i.e., the capacitance of inner conductive cylinder 4) including both the top 4.1 and bottom 4.2 sections, switch 36 is put in its upper position. This puts the two sections 4.1, 4.2 of the sensor (and their respective capacitances C₁ and C₂) in parallel. The controller 34 in concert with switch 39 and comparator 38 may then compute the unknown value of (C₁+C₂).

Ascertaining the value of C₁ cannot be done by just connecting the resistor 37 to it because the capacitance of the wire connecting C₁ to the electronics through the upper section 4.2 of the inner cylinder 4 has a significant stray capacitance, C₁₂, coupling C₁ to the top of C₂. In order to nullify this effect, switch 36 is moved to its lower position, causing buffer amplifier 35 to force the top of C₂ to the same voltage as the top of C₁. Consequently, the voltage across C₁₂ is substantially zero, resulting in no significant current flowing through it regardless of its value, thereby removing its effect on the measurement of C₁.

Thus, the value of either of C₁ (the capacitance of the bottom section 4.2) or C₁+C₂ (the capacitance of the entire sensor 4) may be accurately read, depending on the position of switch 36.

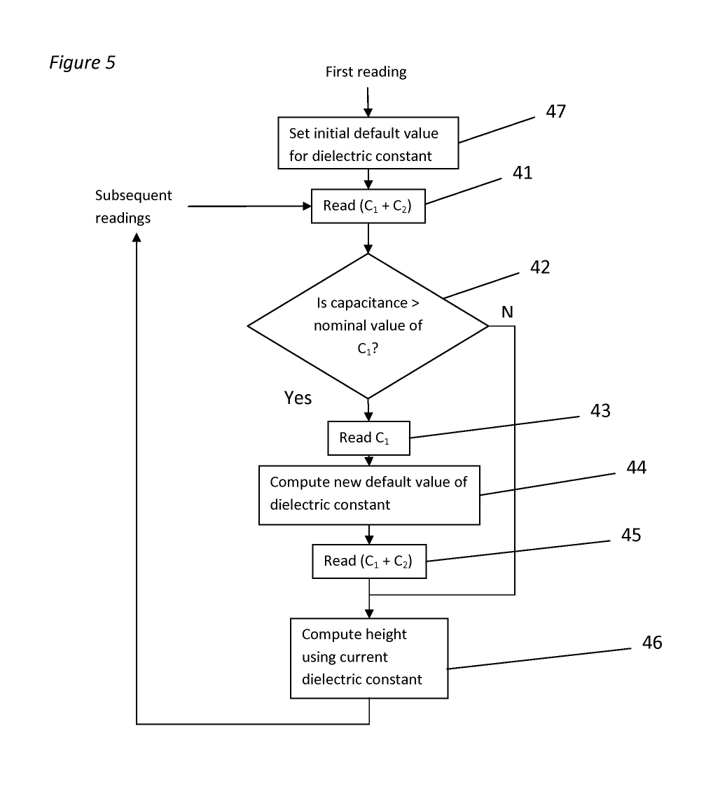

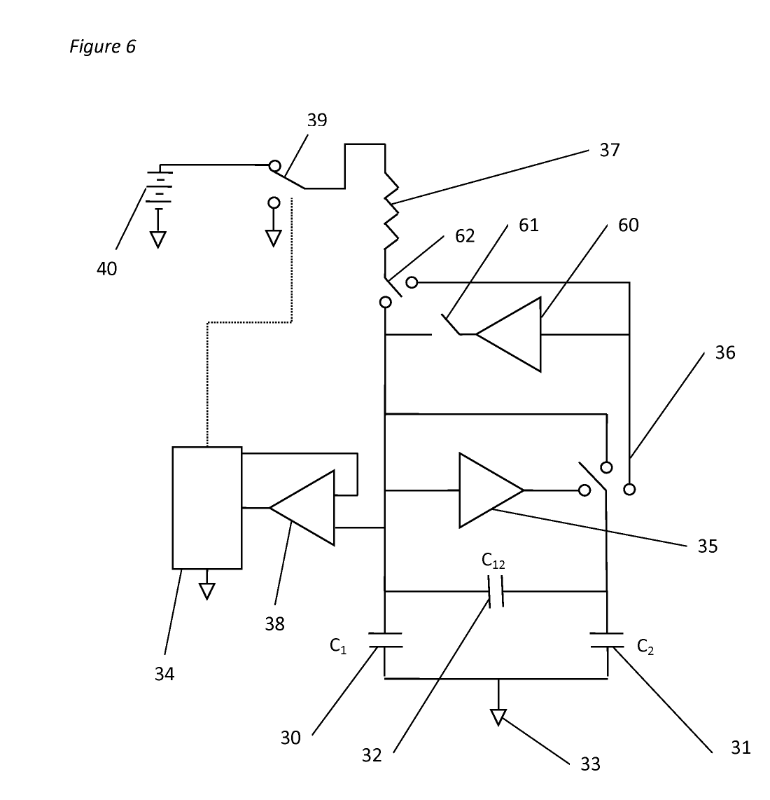

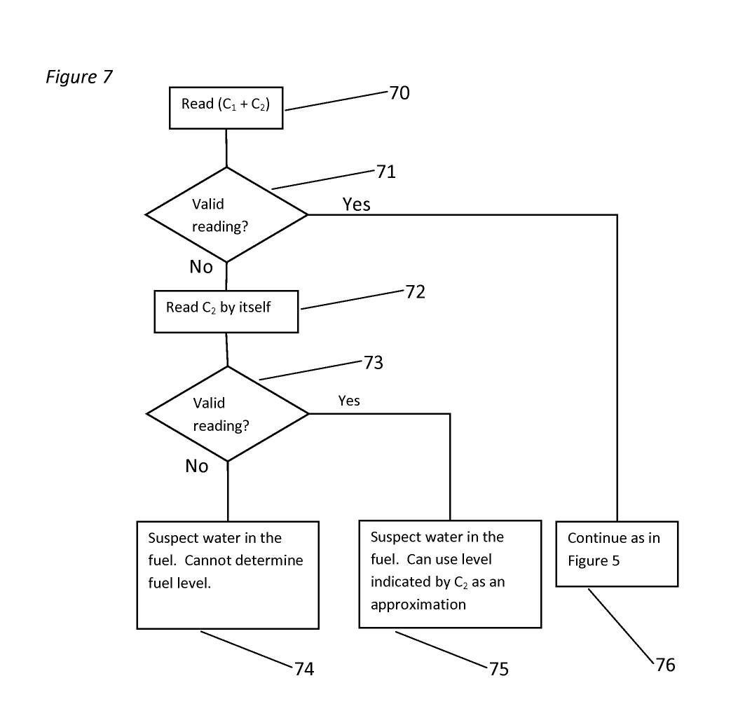

FIG. 5 is a flowchart of how the system operates. The first time the system is used, an initial default value for the dielectric constant of the fuel is used 47. Subsequent readings use the previously calculated value for the initial dielectric constant value. The system must first determine whether there is enough fuel in the tank to enable the sensor to calculate the dielectric constant of the fuel. To do this, it first reads the sensor as a whole (C₁+C₂) 41. If the value of the combined capacitance exceeds the nominal value of C₁ (in other words, if the depth of the fuel appears to exceed the height of the bottom section CO 42, then the dielectric constant of the fuel is calculated from a reading of the capacitance of C₁ alone, 43.

Since the geometry of C₁ is known, the dielectric constant of the fuel may be calculated from the capacitance of C₁ alone, 44. This calculated fuel dielectric value is used in subsequent readings until a new one is calculated. The combined capacitance of C₁+C₂ is then measured 45, and the height of the fuel column in the sensor is then calculated using the most recently calculated fuel dielectric constant 46.

Capacitive sensors are especially susceptible to the presence of water in fuel because the electrical conductivity of water shorts out the small capacitance that is being read at C₁. Because the density of water exceeds that of diesel fuel, if there is water in the fuel tank, it will accumulate at the bottom of the tank, where C₁ is located. With a single section sensor such as in the prior art and shown in FIG. 1, any water in the bottom of the fuel tank will render reading of fuel levels impossible. With a dual section sensor in accordance with the herein disclosed systems and method and as shown in FIG. 2, the water will first short out the bottom section of the sensor before it reaches a level in which it will short out the upper section. Thus, if the bottom section C₁ cannot be read, but the upper section C₂ can, it is an indication that there is water in the bottom of the tank. Further, if the water does not reach upper section C₂, an estimate of the level of fuel in the tank can still be provided based on C₂ alone.

FIG. 6 presents an exemplary embodiment of electronics that may be used to detect the presence of water in the fuel. It is based on the readout method described previously, but adds the ability to read C₂ alone in a manner similar to that used in reading C₁ alone, described previously. FIG. 6 is similar to FIG. 4, modified as follows: an additional pole is added to switch 36, allowing C₂ to be connected to buffer amplifier 60 and resistor 37. Switch 61 allows buffer 60 to be connected to the top of C₁ or not. Switch 62 allows resistor 37 to be connected to either the top of C₁ or the top of C₂.

The foregoing discussions relating to measuring C₁ in the unmodified switch of FIG. 4 are still applicable to the modified switch of FIG. 6 if switch 62 is in its down position, switch 61 is open, and switch 36 does not use the right-most position. However, if it is desired to read C₂ alone, then switch 36 is moved to its rightmost position, Switch 61 is closed, and switch 62 is moved to its rightmost position. This allows resistor 37 to charge C₂ and allows buffer 60 to drive C₁ to the same voltage as appears on C₂, negating the effects of C₁ and C₁₂ as was shown previously. C₂ may then be read independently of C₁ and C₁₂.

A flowchart using this modification is shown in FIG. 7. It begins by reading (C₁+C₂) as in FIG. 5. If a valid reading is obtained, then the fuel is not contaminated by water, and the process can continue 76 as in FIG. 5. If a valid reading cannot be obtained for (C₁+C₂), that implies the presence of water in the fuel. Then, an attempt is made to read C₂, the upper section, by itself 72. If a valid reading of C₂ is obtained 73, then it may be assumed that water was shorting out C₁ but not C₂. Thus, C₂ may still be used to get an uncalibrated fuel level, while at the same time reporting the presence of water in the fuel 75. If a valid reading still cannot be obtained, it implies that the contamination is shorting out both C₁ and C₂, making any reading of fuel level impossible 74.

All references, including publications, patent applications, and patents, cited herein are hereby incorporated by reference to the same extent as if each reference were individually and specifically indicated as incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The embodiments may be described in terms of functional block components and various processing steps. Such functional blocks may be realized by any number of components that perform the specified functions.

The particular implementations shown and described herein are illustrative examples of the invention and are not intended to otherwise limit the scope of the invention in any way. For the sake of brevity, conventional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Expressions such as “at least one of,” when preceding a list of elements, modify the entire list of elements and do not modify the individual elements of the list.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

The words “mechanism” and “element” are used herein generally and are not limited solely to mechanical embodiments. Numerous modifications and adaptations will be readily apparent to those skilled in this art without departing from the spirit and scope of the invention.

### TABLE OF REFERENCE CHARACTERS

1 capacitive fuel sensor
2 fuel tank
3 outer conductive cylinder; first conducting plate
4 inner conductive cylinder; second conducting plate; two-section plate
4.1 first second conducting plate portion; top inner conductive cylinder portion
4.1a immersed portion of first second conducting plate portion
4.2 second second conducting plate portion; bottom inner conductive cylinder portion
5 fuel level
6 external connector
7 protective case
8 fuel sensor electronics
9 inner conductive cylinder wire
9.1 top inner conductive cylinder wire
9.2 bottom inner conductive cylinder wire
10 outer conductive cylinder wire
11 electrical insulator
20-22 capacitor connection points
30 C₁
31 C₂
32 C₁₂
33 ground
34 controller
35 unity gain analog buffer amplifier
36 switch
37 resistor
38 level comparator
39 switch
40 battery
41-47 process elements
60 buffer amplifier
61 buffer amplifier switch
62 switch
70-76 process elements

What is claimed is:

1. A self-calibrating liquid fuel level sensor, comprising:
a calibrator that determines a dielectric constant of a liquid fuel;
a fuel depth capacitance sensor that determines a capacitance of an unknown depth of the fuel; and
a processor that calculates a determined depth based on the unknown depth using the dielectric constant and the capacitance.

2. The sensor of claim 1, further comprising:
a first conductive member that acts as a charge plate of a first capacitor;
a second conductive member that is electrically isolated from the first conductor member that acts as a charge plate of a second capacitor ; and
a third conductive member that acts as an opposite charge plate of the first capacitor and the second capacitor;
wherein the calibrator comprises the first conductive member, the third conductive member, and elements for determining capacitance including a processor comprising algorithms.

3. The sensor of claim 1, wherein:
the third conductive member is a hollow cylinder; and
the first and second conductive members are each hollow cylinders that reside concentrically within the third conductive member.

4. The sensor of claim 1, wherein the elements for determining capacitance comprise:
a resistor that is connected to the first conducting member through which the first capacitor and the second capacitor may be at least one of charged and discharged; and
a controller that measures at least one of charge and discharge times of the first and second capacitors to determine capacitance of the first and second capacitors using a standard exponential charge and discharge formula for resistor capacitor networks.

5. The sensor of claim 4, further comprising:
a charge-discharge switch that alternately applies a ground or a voltage signal to one end of the resistor, the other end of the resistor being connected to the first capacitor.

6. The sensor of claim 5, wherein the controller operates the switch based on a threshold value.

7. The sensor of claim 4, further comprising:
a parallel capacitor switch that alternately connects or disconnects the second capacitor in parallel with the first capacitor between ground and an other end of the resistor.

8. A method of determining a level of fuel in a tank, comprising:
determining a dielectric constant of fuel in a tank;
measuring a capacitance of an unknown depth of the fuel in the tank; and
calculating the depth using the dielectric constant and the capacitance.

9. The method of claim 8, wherein the determining of the dielectric constant comprises:
providing a first conducting member that acts as a charge plate of a first capacitor;
providing a second conductive member that is electrically isolated from the first conductor member that acts as a charge plate of a second capacitor;
providing a third conductive member that acts as an opposite charge plate of the first capacitor and the second capacitor;
completely submerging the first conducting member in the fuel;
measuring a capacitance of the first capacitor; and
calculating the dielectric constant based on the measured capacitance of the first capacitor.

10. The method of claim 9, wherein measuring the capacitance comprises:
connecting a resistor to the first conducting member through which the first capacitor and the second capacitor may be at least one of charged and discharged; and
measuring, using a controller, at least one of a charge and a discharge time of the first and second capacitors to determine capacitance of the first and second capacitors using a standard exponential charge and discharge formula for resistor capacitor networks.

11. The method of claim 10, further comprising:
operating a charge-discharge switch to alternately apply a ground or a voltage signal to one end of the resistor, the other end of the resistor being connected to the first capacitor.

12. The method of claim 11, further comprising:
detecting a threshold value by the controller; and
triggering the operating of the charge-discharge switch based on exceeding the threshold value.

13. The method of claim 10, further comprising:
operating a parallel capacitor switch that alternately connects or disconnects the second capacitor in parallel with the first capacitor between ground and an other end of the resistor.

14. The method of claim 9, wherein:
the third conductive member is a hollow cylinder; and
the first and second conductive members are each hollow cylinders that reside concentrically within the third conductive member.
